(19) United States
(12) Patent Application Publication
(10) Pub. No.: US 2020/0269751 A1
(43) Pub. Date: Aug. 27, 2020

(54) LIGHTING MODULE

(71) Applicant: KOITO MANUFACTURING CO., LTD., Tokyo (JP)

(72) Inventor: Naoki TATARA, Shizuoka-shi, Shizuoka (JP)

(21) Appl. No.: 16/643,745

(22) PCT Filed: Aug. 28, 2018
(86) PCT No.: PCT/JP2018/031717

§ 371 Date: Mar. 2, 2020

(30) Foreign Application Priority Data
Sep. 4, 2017 (JP) 2017-169490

(51) Int. Cl. B60Q 1/50; B60Q 3/217; B60Q 1/00; F21V 23/04

(52) U.S. Cl. CPC B60Q 1/50; B60Q 3/217; F21W 2102/40; F21V 23/0478; B60Q 1/0023

(57) ABSTRACT

To provide a low-cost, small-sized illumination module that reduces an anxiety of a vehicle user when an automatic entrance door is opened and closed. An illumination module (1) includes a foot illumination lamp (4) that illuminates a lower side of an automatic entrance door (51) of a vehicle (50) and a door open/close aspect notification lamp (5) that notifies a user of the vehicle (50) of an open/close aspect of the automatic entrance door (51).

### TECHNICAL FIELD

The present invention relates to an illumination module that reduces an anxiety of a vehicle user at a time of opening and closing an automatic entrance door.

### BACKGROUND ART

In recent years, for solving a driver shortage in a depopulated region and ensuring simple transportation for a short distance, use of a fully autonomous vehicle that does not need a driver has been examined. Further, in such a vehicle, a technique that informs a user of a state of the vehicle to relieve an anxiety about unattended operation has been desired.

As a part of the technique, PATENT LITERATURE 1 discloses a technique that leaves an impression that an approaching vehicle itself detects a user of the vehicle on the user of the vehicle to ensure reducing the anxious feeling about a contact with the vehicle. PATENT LITERATURE 2 discloses a technique that detects a user of a vehicle to cause the user to follow a foot illumination, so as to remove the anxious feeling of the user of the vehicle about getting in and out at night.

### CITATION LIST

### Patent Literature

### PATENT LITERATURE 1: JP-A-2016-166013

### PATENT LITERATURE 2: JP-A-2017-24647

### SUMMARY OF THE INVENTION

### Problems to be Solved by the Invention

In the autonomous vehicle, there is no driver, and thus it is assumed that a door for getting in and out also operates by fully automatically opening and closing. In this case, the user of the autonomous vehicle cannot communicate with any driver because of being unattended. Therefore, the user cannot obtain timings of opening and closing the door or a stop, cannot determine whether the user can get in the vehicle or not, and consequently has the anxiety about an accident of being caught when an automatic opening and closing door is closed while the user gets in and out of the vehicle, and the like. The inventions of PATENT LITERATURES 1 and 2 have a problem in that the inventions cannot eliminate such an anxiety of the user in association with the open and close of the automatic opening and closing door.

This application has been made in consideration of the above-described problems, and provides a low-cost, small-sized illumination module that reduces the anxiety of the vehicle user at a time of opening and closing an automatic entrance door of the vehicle.

### Solution to the Problems

An illumination module includes a foot illumination lamp that illuminates a lower side of an automatic entrance door of a vehicle and a door open/close aspect notification lamp that notifies a user of the vehicle of an open/close aspect of the automatic entrance door.

(Action) The door open/close aspect notification lamp that is integrally disposed with the illumination module together with the foot illumination lamp notifies the user of the vehicle of an operation timing and an operation aspect regarding the automatic entrance door during a stop or during an operation.

In the illumination module, the door open/close aspect notification lamp is configured to be turned on and off in a getting in/out vehicle permission aspect that notifies the user of the vehicle of an open operation stop of the automatic entrance door.

(Action) The door open/close aspect notification lamp notifies the user of the vehicle of a timing of a start of getting in and out of the vehicle with the automatic entrance door.

In the illumination module, the door open/close aspect notification lamp is configured to be turned on and off in a close preannounce aspect that preliminarily notifies the user of the vehicle of a start of a close of the automatic entrance door.

(Action) The door open/close aspect notification lamp notifies the user of the vehicle with the automatic entrance door of a timing of the start of the close of the automatic entrance door.

In the illumination module, a light of the door open/close aspect notification lamp is oriented toward at least one of an outside or an inside of the vehicle.

(Action) The door open/close aspect notification lamp operates as a door open/close aspect notification lamp for getting in the vehicle when the light of the door open/close aspect notification lamp is oriented toward the outside of the vehicle. The door open/close aspect notification lamp operates as a door open/close aspect notification lamp for getting out of the vehicle when the light of the door open/close aspect notification lamp is oriented toward the inside of the vehicle. The door open/close aspect notification lamp doubles as a door open/close aspect notification lamp for getting in and getting out of the vehicle when the light of the door open/close aspect notification lamp is oriented toward both the inside and outside.

The illumination module includes a detection camera that detects a human outside the vehicle.

(Action) The door open/close aspect notification lamp is actuated at a timing based on a detection result of a user of the vehicle who is waiting for getting in the vehicle outside the vehicle.

### Effects of the Invention

With the illumination module, the door open/close aspect notification lamp notifies the user of the vehicle of an operation timing and an operation aspect regarding the automatic entrance door during a stop or during an operation to ensure reducing the anxiety of the vehicle user about the automatic entrance door. The door open/close aspect notification lamp is disposed in the illumination module common to that of the foot illumination lamp, and this ensures the reduced cost and the decreased installation space in the vehicle compared with disposing in different illumination modules.

With the illumination module, the door open/close aspect notification lamp notifies the user of the vehicle of the open operation stop of the automatic entrance door to prompt the user to get in and out of the vehicle with the automatic entrance door. This ensures reducing the anxiety of the vehicle user at a time of getting in and out of the vehicle with the automatic entrance door.

With the illumination module, the door open/close aspect notification lamp notifies the user of the vehicle with the automatic entrance door of the timing of the start of the close of the automatic entrance door to ensure reducing the anxiety of the vehicle user about an accident of being caught in the door at the time of getting in and out of the vehicle with the automatic entrance door.

With the illumination module, the door open/close aspect notification lamp ensures reducing the anxiety of the user of the vehicle who intends to get in the vehicle with the automatic entrance door, the user of the vehicle who intends to get out of the vehicle with the automatic entrance door, or both the users who intend to get in and out, about the automatic entrance door.

The illumination module ensures reducing the anxiety of the user of the vehicle about the automatic entrance door by operating the door open/close aspect notification lamp and the automatic entrance door soon after the vehicle arrives based on the detection result of the user of the vehicle by the detection camera (*claim 5).

### BRIEF DESCRIPTION OF THE DRAWINGS

FIG. 1(a) is a drawing of a part of a vehicle to which an illumination module of a first embodiment is mounted as seen from an outside of the vehicle on a left side.

FIG. 1(b) is a cross-sectional view taken along I-I in FIG. 1(a).

FIG. 2(a) is a drawing of a part of the vehicle to which the illumination module of the first embodiment is mounted as seen from an inside of the vehicle.

FIG. 2(b) is an explanatory diagram regarding functions of the illumination module of the first embodiment.

FIG. 3(a) is a drawing of a part of a vehicle to which an illumination module of a second embodiment is mounted as seen from an outside of the vehicle on a left side.

FIG. 3(b) is an explanatory diagram regarding functions of the illumination module of the second embodiment.

### DESCRIPTION OF THE EMBODIMENTS

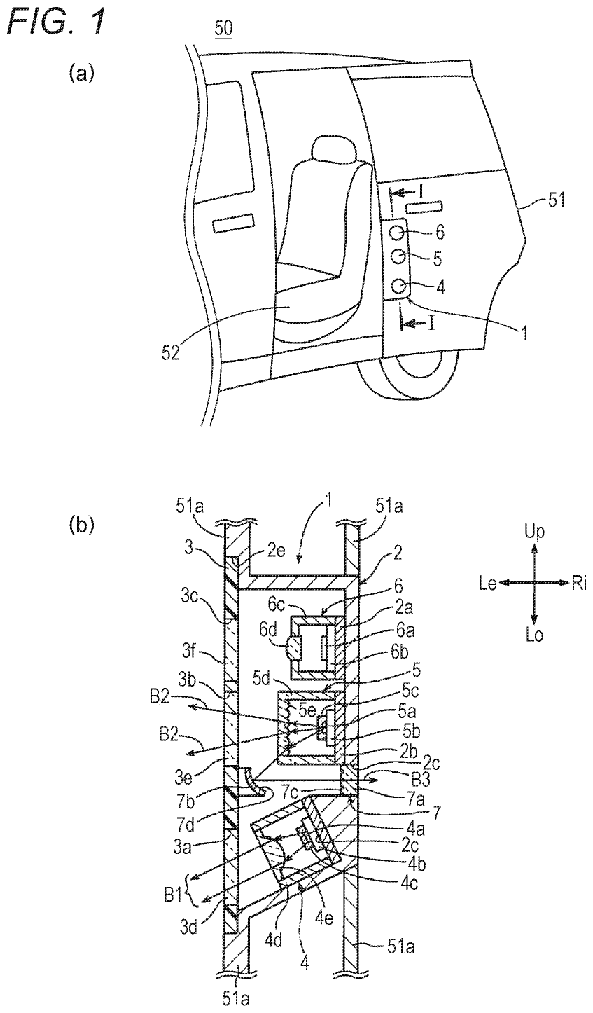

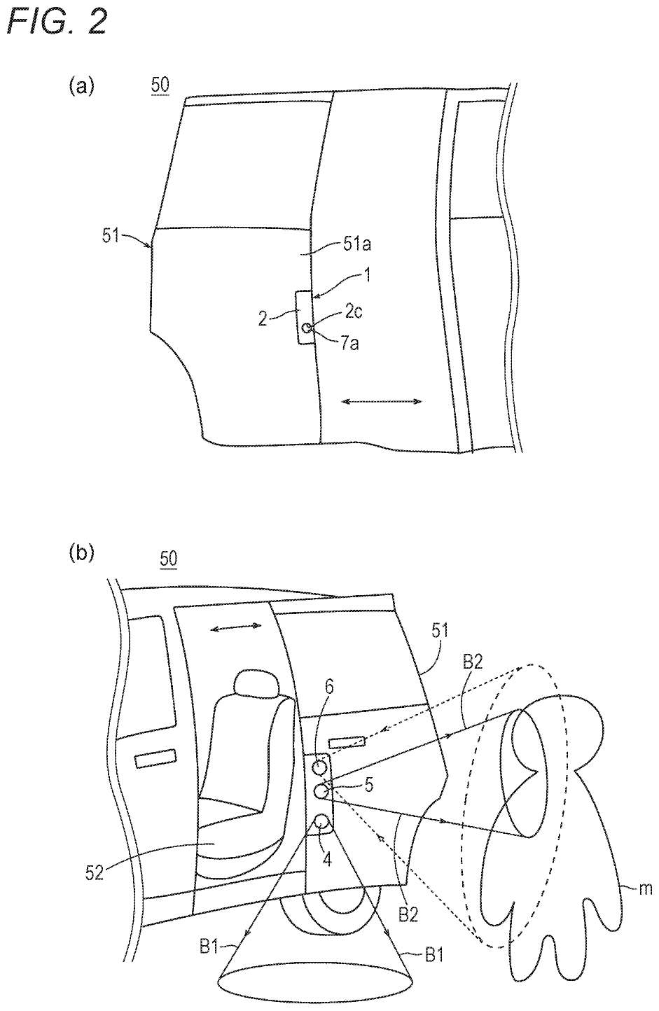

The following describes preferred embodiments of the present invention based on FIG. 1 to FIG. 3. In FIG. 2, respective directions of a vehicle are described as (upper: lower: left: right=Up: Lo: Le: Ri).

First, an illumination module 1 of a first embodiment is described using FIG. 1 and FIG. 2. As illustrated in FIG. 1(a), as an example, the illumination module 1 of the first embodiment is installed to an automatic entrance door 51 on a left side of the vehicle for getting in and out of a rear seat 52 of a vehicle 50. The vehicle 50 to which the automatic entrance door 51 is installed is a fully autonomous vehicle and the like. The fully autonomous vehicle and the like are assumed to be used in a depopulated region where drivers are insufficient and for short distance travel from the closest station to home and the like, are driven without a driver, and have no communication between a passenger and a crew of the vehicle. The automatic entrance door 51 is an automatic slide door that automatically slides back and forth, for example, electrically.

The illumination module 1 illustrated in FIG. 1(b) includes a main body portion 2 that is formed as a part of a body 51a of the automatic entrance door 51, a front surface cover 3, a foot illumination lamp 4, a door open/close aspect notification lamp 5, a detection camera 6, and an indoor optical system 7.

The main body portion 2 illustrated in FIG. 1(b) includes a first mounting portion 2a, a second mounting portion 2b, a circle hole 2c, a third mounting portion 2d, and a mounting portion 2e of the front surface cover 3. The first mounting portion 2a is formed of a metal and the like and has a board shape to which the detection camera 6 is installed. The second mounting portion 2b has a board shape to which the door open/close aspect notification lamp 5 is installed. The third mounting portion 2d is an inclined portion to which the foot illumination lamp 4 is installed. The mounting portion 2e has a stepped shape. The circle hole 2c is provided between the second mounting portion 2b and the third mounting portion 2d, and the foot illumination lamp 4 in a state of being oriented obliquely downward is fixed to the third mounting portion 2d.

The front surface cover 3 illustrated in FIG. 1(b) is formed of a non-transparent resin and the like, includes circle holes (3a to 3c), and is fixed to the mounting portion 2e of the main body portion 2. Lenses (3d to 3f) made from a transparent or translucent resin, a glass, and the like are installed to the circle holes (3a to 3c), respectively.

The foot illumination lamp 4 is formed by an excitation light source 4a, such as an LED, a base plate 4b, a phosphor 4c, a non-transparent cover 4d, and a transparent or non-transparent plano-convex-lens portion 4e, and is arranged so as to be opposed to the lens 3d. The excitation light source 4a is turned on and off based on a control by a control device (not illustrated) and generates a white light together with the phosphor 4c integrated with the excitation light source 4a on the base plate 4b. The plano-convex-lens portion 4e is disposed on a front end of the cover 4d in a state in which a convex portion is opposed to the excitation light source 4a while a flat portion is opposed to the lens 3d. The foot illumination lamp 4 irradiates a left of the vehicle 50 obliquely downward with a white light B1 via the plano-convex-lens portion 4e and the lens 3d to brightly illuminate a proximity of feet of a person getting in/out outside the vehicle.

The door open/close aspect notification lamp 5 illustrated in FIG. 1(b) is formed by an excitation light source 5a such as an LED, a base plate 5b, a phosphor 5c, and a yellow transparent or non-transparent front surface cover 5d, and is arranged so as to be opposed to the lens 3e. The front surface cover 5d is formed in a cylindrical shape with a ceiling portion. The front surface cover 5d partially includes a diffuser lens portion 5e that has a plurality of convex portions opposed to the excitation light source 5a inside a front end portion. The excitation light source 5a generates a white light via the phosphor 5c and generates yellow lights via the yellow diffuser lens portion 5e. Most of the yellow lights (lights B2) that are turned on and off based on the control by the control device (not illustrated) and are generated by the excitation light source 5a are diffused by the diffuser lens portion 5e to be emitted outside the lens 3e. Note that the light by the excitation light source 5a is not limited to yellow. Further, the door open/close aspect notification lamp 5 may freely emit the lights by including excitation light sources with a plurality of colors (such as, three primary colors of red, blue, and green) that are independently turned on and off by the control device (not illustrated).

The detection camera 6 illustrated in FIG. 1(b) is formed by an imaging device 6a, a base plate 6b, a cover 6c, and a camera lens 6d, and is arranged so as to be opposed to the lens 3f The camera lens 6d is formed as a transparent or translucent plano-convex lens and is disposed on a front end of the non-transparent cover 6c in a state in which a flat portion is opposed to the imaging device 6a while a convex portion is opposed to the lens 3f The detection camera 6 is coupled to the control device (not illustrated) and detects the person getting in/out, another passerby (bicycle and pedestrian), and the like who are on a road and the like outside the vehicle 50, based on a light received by the imaging device 6a via the camera lens 6d and the lens 3f. The door open/close aspect notification lamp 5 is turned on and off in a predetermined aspect in response to the control by the control device (not illustrated) based on a detection result of a customer getting in/out outside the vehicle by the detection camera 6.

Note that the detection camera 6 illustrated in FIG. 1(b) may be omitted as long as an open/close control start of the automatic entrance door 51 and a turning on/off control start of the door open/close aspect notification lamp 5 are configured to be executed by a trigger of stopping a travel of the vehicle 50, and these controls are executed regardless of presence/absence of the customer getting in/out outside the vehicle. However, since unnecessary open and close of the automatic entrance door 51 and unnecessary turning on and off of the door open/close aspect notification lamp 5 do not need to be executed when the customer getting in/out is not present, it is preferred that the detection camera 6 be disposed.

Since the door open/close aspect notification lamp 5 and the detection camera 6 are disposed in the illumination module 1 same as the foot illumination lamp 4, it is advantageous in that cost is low and a space saving for the installation to the vehicle 50 is achieved compared with the case of being disposed in another independent illumination module.

The indoor optical system 7 illustrated in FIG. 1(b) is formed by an inner lens 7a and a reflecting mirror 7b. The inner lens 7a is formed of a transparent or translucent resin, a glass, and the like in a columnar shape, and is fixed to the circle hole 2c of the main body portion 2. In the inner lens 7a, a diffuser lens portion 7c having a plurality of protrusions oriented toward the front surface cover 3 is disposed. The reflecting mirror 7b has a reflecting surface 7d having a free-form surface shape and is disposed in a rear surface 3g of the front surface cover 3 between the circle holes 3a and 3b. The reflecting surface 7d is arranged so as to be opposed to both the diffuser lens portion 5e of the door open/close aspect notification lamp 5 and the diffuser lens portion 7c of the inner lens 7a.

As illustrated in FIG. 1(b), a part (light B3) of the lights generated by the excitation light source 5a of the door open/close aspect notification lamp 5 is transmitted through the diffuser lens portion 5e to be diffused toward the reflecting mirror 7b. The light B3 reflected by the reflecting surface 7d is diffused by the diffuser lens portion 7c, and then an inside of the vehicle 50 from the inner lens 7a is irradiated with the light B3. As illustrated in FIG. 1(b) and FIG. 2(a), the inner lens 7a receives the light B3 transmitted through the diffuser lens portion 7c to indirectly emit the light, so as to function as the door open/close aspect notification lamp 5 that shines toward the inside of the vehicle 50. Note that the indoor optical system 7 can be omitted. However, since the indoor optical system 7 notifies an occupant who is in the vehicle 50 of an operation aspect of the automatic entrance door 51 to ensure reducing the anxiety at a time of open and close, it is preferred that the indoor optical system 7 be disposed.

Next, functions of the illumination module 1 of the first embodiment is described. In the vehicle 50 during the travel, the automatic entrance door 51 is closed, and both the foot illumination lamp 4 and the door open/close aspect notification lamp 5 are turned off. When the vehicle 50 stops at a predetermined position where a passenger gets in or out, and the detection camera 6 detects an occupant m of the vehicle 50, the foot illumination lamp 4 is turned on to irradiate feet of the occupant m with the light B1 based on the control by the control device (not illustrated) as illustrated in FIG. 2(b), and brightly illuminates a periphery of a boarding entrance of the vehicle 50 even when there is no night lamp and the like at a riding place. The door open/close aspect notification lamp 5 starts a flashing for the occupant m and an occupant who is in the vehicle, using the lights B2 and B3 (not illustrated in FIG. 2(b)). The automatic entrance door 51 is configured to start opening after the flashing of the door open/close aspect notification lamp 5.

Outside the automatic entrance door 51, an instruction, for example, “Never touch the entrance door while the lamp at the center flashes yellow, and please get in after the lamp is turned on” is displayed to call an attention of the occupant m who is waiting for getting in. Inside the automatic entrance door 51, an instruction, “Never touch the entrance door while the circle lamp (which is the inner lens 7a in FIG. 2(a)) on the door flashes yellow, and please get out after the lamp is turned on” is displayed to also call an attention of an occupant who is waiting for getting out of the vehicle.

After the automatic entrance door 51 has fully opened and then stopped, the door open/close aspect notification lamp 5 transitions from a flashing that represents no touch to the automatic entrance door 51 and no getting in or out of the vehicle to a lighting that represents a permission for getting in and out of the vehicle. Users inside and outside the vehicle 50 visually perceive that the door open/close aspect notification lamp 5 and the inner lens 7a are turned on and off in a getting in/out vehicle permission aspect that changes from the flashing representing no getting in or out to the lighting that indicates a start of getting in and out so as to easily obtain a timing of a start of getting in and out of the vehicle. This enables the users to get in and out of the vehicle at ease even when there is no crew in the vehicle 50.

Meanwhile, even when the user who intends to get in the vehicle 50 and the user who intends to get out of the vehicle 50 can obtain the timing of the start of getting in and out of the vehicle from the turning on and off using the getting in/out vehicle permission aspect of the door open/close aspect notification lamp 5, the users cannot know when the automatic entrance door 51 starts closing, and thus the anxiety of the users about an accident of being caught in the automatic entrance door 51 needs to be eliminated.

Therefore, before the automatic entrance door 51 is started to be closed prior to a departure of the vehicle 50, the door open/close aspect notification lamp 5 illustrated in FIGS. 2(a) and 2(b) is turned on and off in a close preannounce aspect that preannounces the close based on the control device (not illustrated). Specifically, the door open/close aspect notification lamp 5 is configured to be switched to a flashing at high speed at an interval faster than a flashing during the operation of the automatic entrance door 51 from the lighting at a predetermined period before, such as 10 seconds before, the start of the close of the automatic entrance door 51.

At a position illustrated in FIG. 2(b), which is reached by the light B1 of the foot illumination lamp 4 outside the automatic entrance door 51, an instruction, for example, “Please do not get in the vehicle because the entrance door will be closed immediately after the yellow lamp at the center is switched from the lighting to the flashing fast” is displayed. Inside the automatic entrance door 51, an instruction, for example, “Please do not get out of the vehicle because the entrance door will be closed immediately after the circle lamp (which is the inner lens 7a) on the door is switched from the lighting to the flashing fast” is displayed.

Consequently, the users of the vehicle 50 inside and outside the vehicle 50 visually perceive that the door open/close aspect notification lamp 5 and the inner lens 7a are turned on and off in the close preannounce aspect, which changes from the lighting that represents a getting in/out permission to the flashing fast to preliminarily notify the start of the close of the automatic entrance door 51 so as to easily obtain a timing of the start of the close of the automatic entrance door 51. This eliminates the anxiety about the accident of being caught and the accident of being caught itself even when there is no crew in the vehicle 50.

Note that after the start of the close of the automatic entrance door 51, the door open/close aspect notification lamp 5 is configured to be switched from the flashing fast before the start of the close to a slower flashing that indicates being in operation where the automatic entrance door 51 must not be touched with a hand, and be turned off after a termination of the close.

Note that the door open/close aspect notification lamp 5 may achieve turning on and off in the getting in/out vehicle permission aspect and the close preannounce aspect by disposing a plurality of excitation light sources to generate lights of a plurality of colors, such as green, yellow, and red. Specifically, turning on and off in the getting in/out vehicle permission aspect may be achieved by a red lighting that indicates no getting in or out during opening of the automatic entrance door 51, and changing to a blue lighting that indicates the start of getting in and out after an open operation terminates. Further, turning on and off in the close preannounce aspect may be achieved by changing from the blue lighting that indicates the getting in/out permission to the yellow lighting that preliminarily notifies the start of the close at a predetermined time before the start of the close of the automatic entrance door 51. The door open/close aspect notification lamp 5 is configured to be turned on in red during a close operation of the automatic entrance door 51 and be turned off after a completion of the close. Inside and outside the automatic entrance door 51, “Please get in and out of the vehicle while the door open/close aspect notification lamp 5 is turned on in blue, the entrance door starts to be closed immediately after the door open/close aspect notification lamp 5 is turned on in yellow, and since the entrance door is in operation while the door open/close aspect notification lamp 5 is turned on in red, please do not touch it with a hand and please do not get in or out of the vehicle” is displayed.

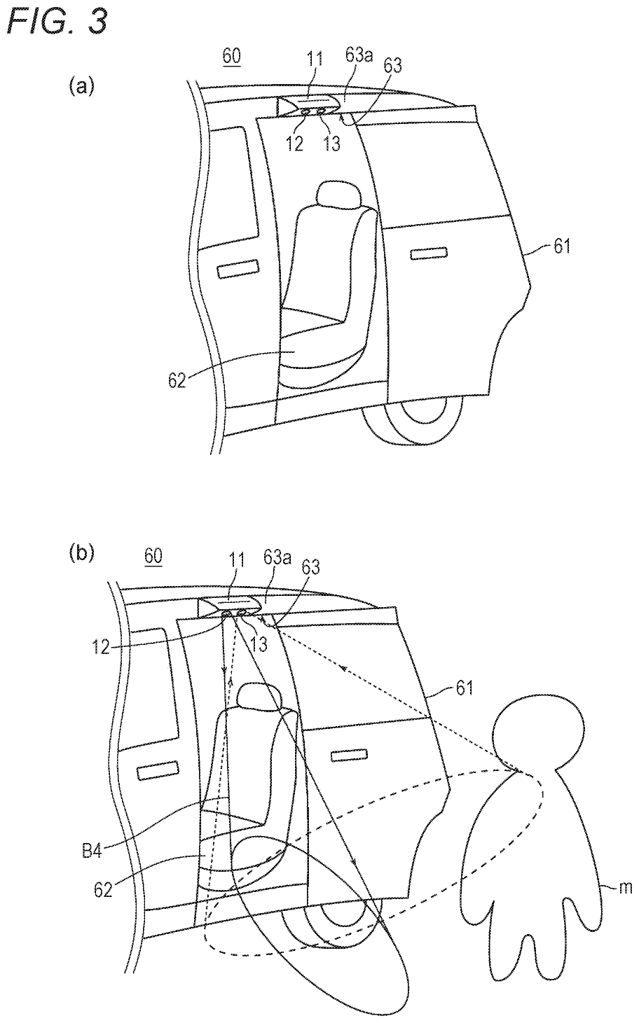

Next, an illumination module 11 of a second embodiment is described using FIG. 3(a), and functions of the illumination module 11 of the second embodiment are described using FIG. 3(b). The illumination module 11 of the second embodiment is installed to an upper portion 63a on a boarding entrance 63 to a rear seat 62 unlike the illumination module 1 of the first embodiment, which is installed to the automatic entrance door 51 of the vehicle 50 in FIG. 1(a). At the boarding entrance 63, an automatic entrance door 61 of a vehicle 60 is opened and closed.

The illumination module 11 illustrated in FIG. 3(a) includes a foot-illumination-lamp-and-door-open/close-aspect-notification lamp 12 and a detection camera 13. The foot-illumination-lamp-and-door-open/close-aspect-notification lamp 12 doubles as two lamps to be downsized, switches a plurality of emission of lights, such as white and yellow (types of emitted light color are not limited to these), based on a control device (not illustrated), and is turned on and off in a predetermined aspect. The foot-illumination-lamp-and-door-open/close-aspect-notification lamp 12 is oriented downward and widely irradiates a proximity of feet of a person getting in/out outside the vehicle from a proximity of the rear seat 62 inside the vehicle with a light B4 when the automatic entrance door 61 is opened. Widely illuminating the inside and outside of the vehicle causes the vehicle 60 of the second embodiment to eliminate the need for the indoor optical system 7 of the first embodiment. The detection camera 13 has a configuration equivalent to that of the detection camera 6 of the first embodiment and is oriented toward the outside of the vehicle 60 to detect the occupant m and the like.

The foot-illumination-lamp-and-door-open/close-aspect-notification lamp 12 switches the emission of light between the white that functions as a foot illumination lamp 4 and the yellow that functions as the door open/close aspect notification lamp 5 based on the control device (not illustrated) and functions as follows.

During travel of the vehicle 60, the automatic entrance door 61 is closed, and the foot-illumination-lamp-and-door-open/close-aspect-notification lamp 12 is turned off. When the vehicle 60 stops and the detection camera 13 detects the occupant m outside the vehicle, the automatic entrance door 61 starts to be opened after the foot-illumination-lamp-and-door-open/close-aspect-notification lamp 12 is turned on as illustrated in FIG. 3(b) to irradiate the feet of the occupant m with the yellow light B4 based on a control by the control device (not illustrated). Outside the automatic entrance door 61, at a position that is reached by the light B4, an instruction, for example, “Please do not get in or out while the yellow lamp is turned on and please get in or get out of the vehicle after the white lamp is turned on” is displayed. The users of the vehicle 60 inside and outside the vehicle 60 visually perceive that the foot-illumination-lamp-and-door-open/close-aspect-notification lamp 12 is turned on and off in a getting in/out vehicle permission aspect that changes from a lighting in yellow that represents no getting in or out to a lighting in white that indicates a start of getting in and out so as to easily obtain a timing of the start of getting in and out of the vehicle, and the white illumination of the feet ensures getting in and out of the vehicle in safety.

Further, before a start of the close of the automatic entrance door 61, the foot-illumination-lamp-and-door-open/close-aspect-notification lamp 12 illustrated in FIGS. 3(a) and 3(b) is turned on and off in a close preannounce aspect that preannounces the close based on the control device (not illustrated). Specifically, for example, the foot-illumination-lamp-and-door-open/close-aspect-notification lamp 12 is configured to be switched from the lighting in white to a flashing yellow a predetermined time before, such as 10 seconds before, the start of the close of the automatic entrance door 61. At the position that is reached by the light B4 outside the automatic entrance door 61, an instruction, for example, “Please do not get in the vehicle because the entrance door will be closed immediately after the yellow lamp flashes” is displayed. The users of the vehicle 60 inside and outside the vehicle 60 visually perceive that the foot-illumination-lamp-and-door-open/close-aspect-notification lamp 12 is turned on and off in the close preannounce aspect that changes from the lighting in white that represents a getting in/out permission to a flashing yellow that preannounces the start of the close of the automatic entrance door 61 so as to easily obtain a timing of the start of the close. This eliminates the anxiety about the accident of being caught and the like. The foot-illumination-lamp-and-door-open/close-aspect-notification lamp 12, which is a flashing yellow, is configured to be switched to a lighting in yellow after the start of the close of the automatic entrance door 61 and is turned off after the close terminates.

Note that while in the second embodiment the foot illumination lamp doubles as the door open/close aspect notification lamp, a drawing lamp that draws a warning display on a road surface, a vehicle body surface, and the like may double as the door open/close aspect notification lamp in order to call an attention of a passerby, an oncoming car, and the like. Further, the illumination module may include a speaker by, for example, the speaker incorporated in the door open/close aspect notification lamp to notify an open/close aspect of the automatic entrance door by a sound from the speaker in conjunction with the turning on and off of the door open/close aspect notification lamp.

This application claims priority from Japanese Patent Application No. 2017-169490 filed with the Japanese Patent Office on Sep. 4, 2017, the entire contents of which are hereby incorporated by reference.

The above description of a specific embodiment of the present invention is disclosed as illustrative. This does not intend to be exhaustive or limit the present invention to the described embodiments as they are. Many modifications and variations will be apparent to one of ordinary skill in the art in light of the above teachings.

### LIST OF REFERENCE SIGNS

1 Illumination module
4 Foot illumination lamp
5 Door open/close aspect notification lamp
6 Detection camera
11 Illumination module
12 Foot-illumination-lamp-and-door-open/close-aspect-notification lamp
13 Detection camera
50 Vehicle
51 Automatic entrance door
60 Vehicle
61 Automatic entrance door

What is claimed is:

1. An illumination module comprising:
a foot illumination lamp that illuminates a lower side of an automatic entrance door of a vehicle; and
a door open/close aspect notification lamp that notifies a user of the vehicle of an open/close aspect of the automatic entrance door.

2. The illumination module according to claim 1, wherein the door open/close aspect notification lamp is turned on and off in a getting in/out vehicle permission aspect that notifies the user of the vehicle of an open operation stop of the automatic entrance door.

3. The illumination module according to claim 1, wherein the door open/close aspect notification lamp is turned on and off in a close preannounce aspect that preliminarily notifies the user of the vehicle of a start of a close of the automatic entrance door.

4. The illumination module according to claim 1, wherein the door open/close aspect notification lamp is oriented toward at least one of an outside or an inside of the vehicle.

5. The illumination module according to claim 1, comprising a detection camera that detects a human outside the vehicle.
